(19) United States
(12) Patent Application Publication
(10) Pub. No.: US 2023/0189359 A1
(43) Pub. Date: Jun. 15, 2023

(54) METHOD AND APPARATUS FOR TRIGGERED TXOP SHARING FOR PEER-TO-PEER COMMUNICATION WITH TWT OPERATION

(71) Applicant: Samsung Electronics Co., Ltd., Suwon-si (KR)

(72) Inventors: Rubayet Shafin, Allen, TX (US); Boon Loong Ng, Plano, TX (US); Vishnu Vardhan Ratnam, Plano, TX (US); Ahmed Atef Ibrahim Ibrahim, Plano, TX (US); Peshal Nayak, Plano, TX (US)

(21) Appl. No.: 18/061,955

(22) Filed: Dec. 5, 2022

Related U.S. Application Data
(60) Provisional application No. 63/289,968, filed on Dec. 15, 2021.

(51) Int. Cl. H04W 76/14; H04W 52/02

(52) U.S. Cl. CPC H04W 76/14; H04W 52/0258

(57) ABSTRACT

Methods and apparatuses for enabling triggered transmission opportunity (TXOP) sharing for peer-to-peer (P2P) communication during a target wake time (TWT) service period (SP) in a wireless local area network. A wireless station (STA) device comprises a transceiver and a processor operably coupled to the transceiver. The transceiver is configured to receive, from an access point (AP), a trigger frame during a TWT SP that corresponds to a trigger-enabled TWT schedule that is configured such that the trigger frame includes an indication that the trigger frame is for a triggered TXOP sharing (TXS) mode that allows P2P communication during the TWT SP. The processor is configured to, based on receipt of the trigger frame, begin a P2P session with a peer STA during the TWT SP.

### CROSS-REFERENCE TO RELATED APPLICATION(S) AND CLAIM OF PRIORITY

This application claims priority under 35 U.S.C. § 119(e) to U.S. Provisional Pat. Application No. 63/289,968 filed on Dec. 15, 2021, which is hereby incorporated by reference in its entirety.

### TECHNICAL FIELD

This disclosure relates generally to efficiency in wireless communications systems. Embodiments of this disclosure relate to methods and apparatuses for enabling triggered transmission opportunity sharing for peer-to-peer communication during a target wake time service period in a wireless local area network communications system.

### BACKGROUND

Wireless local area network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Target Wake Time (TWT) is one of the important features for power management in WI-FI networks, which was developed by IEEE 802.11ah and later adopted and modified into IEEE 802.11ax. TWT enables wake time negotiation between an AP and an associated station (STA) for improving power efficiency. With TWT operation, it suffices for a STA to only wake up at a pre-scheduled time negotiated with another STA or AP in the network. In IEEE 802.11ax standards, two types of TWT operation are possible – individual TWT operation and broadcast TWT operation. Individual TWT agreements can be established between two STAs or between a STA and an AP. On the other hand, with broadcast TWT operation, an AP can set up a shared TWT session for a group of STAs.

The negotiated parameters such as the wake interval, wake duration and initial wake time (offset) highly affect latency, throughput as well as power efficiency, which are directly related to QoS (quality of service) or customer experiences. Services with different traffic characteristics will have different TWT parameter configurations for better QoS. Additionally, the TWT configuration should adapt to network and service status variation.

Restricted TWT (rTWT) operation, which is based on broadcast TWT operation, is a feature introduced with a view to providing better support for latency sensitive applications. Restricted TWT offers a protected service period for its member STAs by sending Quiet elements to other STAs in the basic service set (BSS) which are not members of the restricted TWT schedule, where the Quiet interval corresponding to the Quiet element overlaps with the initial portion of the restricted TWT service period (SP). Hence, it gives more channel access opportunity for the restricted TWT member scheduled STAs, which supports latency-sensitive traffic flow. There are some key characteristics that make restricted TWT operation an important feature for supporting low-latency applications in next generation WLAN systems.

### SUMMARY

Embodiments of the present disclosure provide methods and apparatuses for enabling triggered transmission opportunity (TXOP) sharing for peer-to-peer (P2P) communication during a TWT SP in a wireless network (e.g., a WLAN).

In one embodiment, a wireless STA device is provided, comprising a transceiver and a processor operably coupled to the transceiver. The transceiver is configured to receive, from an AP, a trigger frame during a TWT SP that corresponds to a trigger-enabled TWT schedule that is configured such that the trigger frame includes an indication that the trigger frame is for a triggered TXOP sharing (TXS) mode that allows P2P communication during the TWT SP. The processor is configured to, based on receipt of the trigger frame, begin a P2P session with a peer STA during the TWT SP.

In another embodiment, an AP device is provided, comprising a transceiver and a processor operably coupled to the transceiver. The processor is configured to determine to allow a STA to perform P2P communication during a TWT SP that corresponds to a trigger-enabled TWT schedule, and generate a trigger frame that includes an indication that the trigger frame is for a triggered TXOP sharing (TXS) mode that allows the P2P communication during the TWT SP that corresponds to the trigger-enabled TWT schedule. The transceiver is configured to transmit, to the STA, the trigger frame to trigger the STA to begin a P2P session with a peer STA during the TWT SP.

In another embodiment, a method performed by the wireless STA device is provided, including the steps of receiving, from an AP, a trigger frame during a TWT SP that corresponds to a trigger-enabled TWT schedule that is configured such that the trigger frame includes an indication that the trigger frame is for a triggered TXOP sharing (TXS) mode that allows P2P communication during the TWT SP, and beginning a P2P session with a peer STA during the TWT SP based on receipt of the trigger frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example of triggered TXOP sharing for P2P communication during a TWT SP according to various embodiments of the present disclosure;

FIG. 4 illustrates an example process for triggered TXOP sharing for P2P communication during a TWT SP with a P2P session that is synchronized with parameters of the TWT SP according to various embodiments of the present disclosure;

FIG. 5 illustrates an example process for triggered TXOP sharing for P2P communication during a TWT SP that is synchronized with parameters of the P2P session according to various embodiments of the present disclosure;

FIG. 6 illustrates an example of Triggered TXOP sharing for P2P communication during a TWT SP wherein an MU-RTS TXS Trigger frame is sent after a Basic Trigger frame according to various embodiments of the present disclosure; and

FIG. 7 illustrates an example process for using an MU-RTS TXS Mode 2-enabled TWT schedule to perform triggered TXOP sharing for P2P communication during the corresponding TWT SP according to various embodiments of the present disclosure.

### DETAILED DESCRIPTION

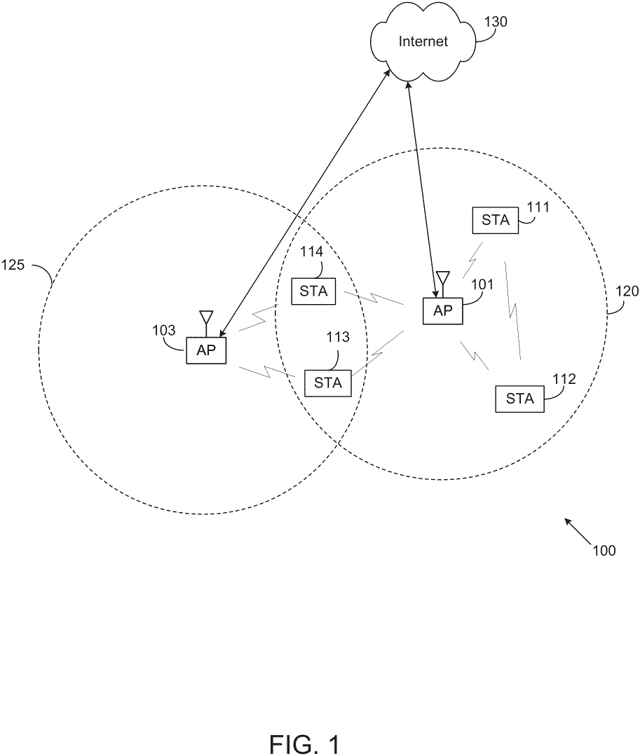

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure further that in various scenarios it is desirable for an AP that has won a TXOP in a WLAN to allocate all or some portion of the TXOP to a STA. The triggered TXOP sharing procedure may be used to allow the AP to use a trigger frame addressed to the STA to inform the STA that it is clear to use the TXOP. This use can include performing uplink (UL) transmissions to the AP or performing P2P communications with a peer STA during the TXOP.

Embodiments of the present disclosure further recognize that two peer STAs may set up a TWT agreement for P2P communication with each other, which an AP is not be aware of. TWT operation places restrictions on when a STA may use a channel, as a STA operating in TWT mode may only transmit during scheduled TWT SPs. Accordingly, if the AP were to allocate a TXOP to a TWT scheduled STA outside of the scheduled TWT SP for P2P communications, the STA would be unable to utilize the allocated TXOP for P2P communications.

There is currently no guidance in the IEEE 802.11 specifications for enabling triggered TXOP sharing for P2P communication during a TWT SP. Accordingly, embodiments of the present disclosure provide mechanisms and frameworks for enabling triggered TXOP sharing for P2P communications during TWT operation.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating triggered TXOP sharing for P2P communication during a TWT SP in a WLAN. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

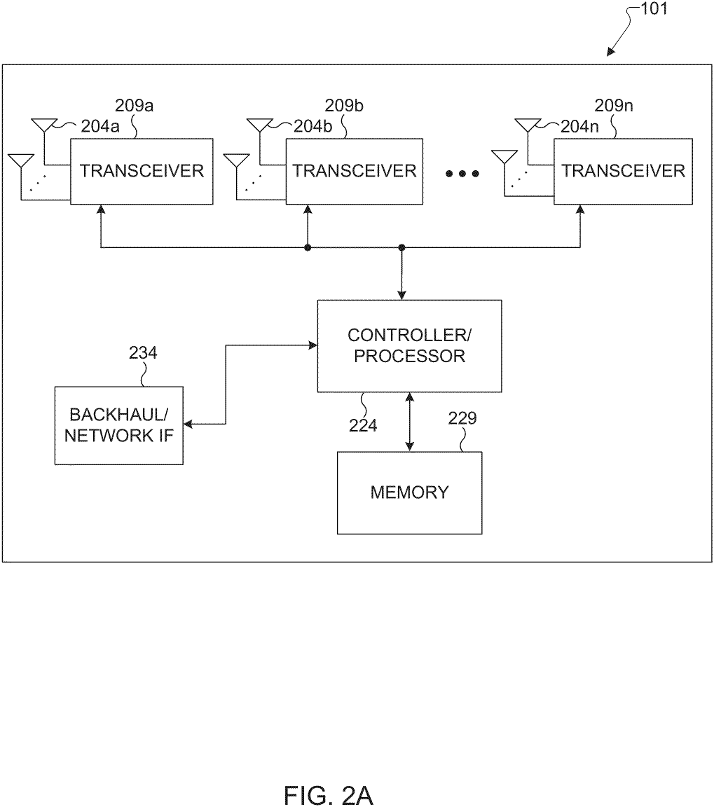

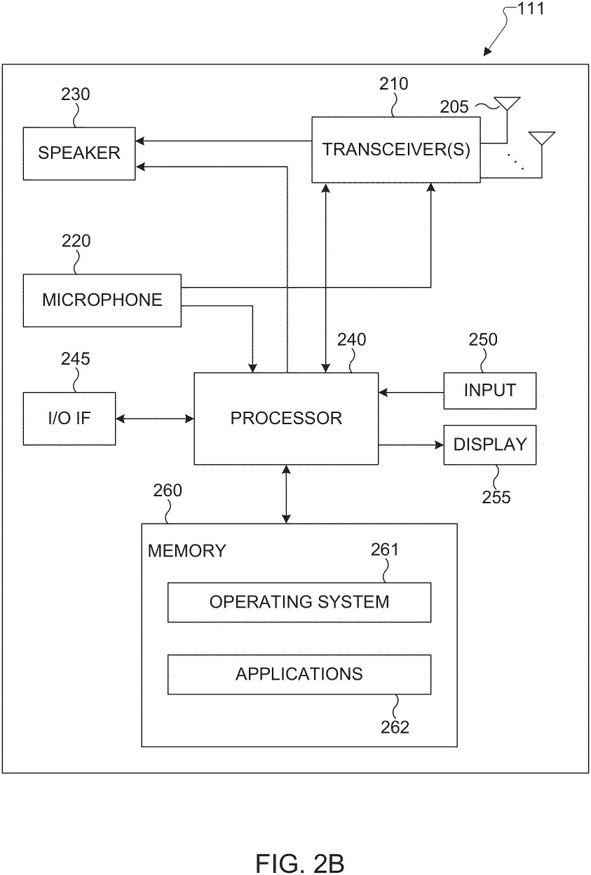

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating triggered TXOP sharing for P2P communication during a TWT SP. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating triggered TXOP sharing for P2P communication during a TWT SP. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives, from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to facilitate triggered TXOP sharing for P2P communication during a TWT SP. In some embodiments, the processor 240 includes at least one microprocessor or microcontroller.

The processor 240 is also capable of executing other processes and programs resident in the memory 260, such as operations for facilitating triggered TXOP sharing for P2P communication during a TWT SP. The processor 240 can move data into or out of the memory 260 as required by an executing process. In some embodiments, the processor 240 is configured to execute a plurality of applications 262, such as applications for facilitating triggered TXOP sharing for P2P communication during a TWT SP. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

According to various embodiments of the present disclosure, in order to enable P2P communication during a TWT SP using Triggered TXOP sharing, a multi-user request to send (MU-RTS) TXS Mode 2-enabled TWT schedule (or agreement) is defined, where MU-RTS TXS Mode 2 is a TXOP sharing mode in which a STA is allowed to perform UL communications with the AP and P2P communications with a peer STA. A TWT SP corresponding to an MU-RTS TXS Mode 2-enabled TWT schedule or agreement is a trigger-enabled TWT SP where the TWT responding AP or the TWT scheduling AP triggers the TWT requesting STA or TWT scheduled STA by sending an MU-RTS TXS Trigger frame (TF) with a Triggered TXOP Sharing Mode subfield in the Common Info field of the MU-RTS TXS Trigger frame set to 2 (an “MU-RTS TXS (Mode 2) Trigger frame”) during that TWT SP.

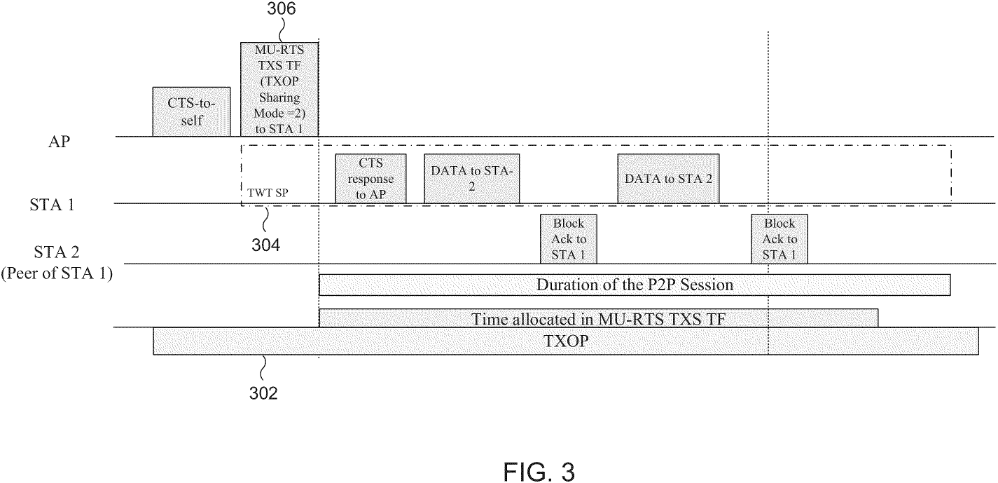

FIG. 3 illustrates an example of triggered TXOP sharing for P2P communication during a TWT SP according to various embodiments of the present disclosure. In the example of FIG. 3, the AP may be AP 101 and is a TWT scheduling AP or TWT responding AP, the STA 1 may be STA 111 and is a TWT scheduled STA or TWT requesting STA, and the STA 2 may be STA 112 and is a peer STA to STA 1. STA 1 is a member STA of an MU-RTS TXS Mode 2-enabled TWT schedule established by the AP.

In the example of FIG. 3, the AP has secured a TXOP 302 that overlaps with an MU-RTS TXS Mode 2-enabled TWT SP 304 associated with the MU-RTS TXS Mode 2-enabled TWT schedule, and initiates triggered TXOP sharing for P2P communications by sending MU-RTS TXS Trigger frame 306 with the Triggered TXOP Sharing Mode subfield in the Common Info field set to 2 at the beginning of the TWT SP 304. Upon receiving the MU-RTS TXS Trigger frame 306 with the Triggered TXOP Sharing Mode subfield in the Common Info field set to 2 during the MU-RTS TXS Mode 2-enabled TWT SP 304, STA 1 can start sending frames to its peer STA 2.

In some embodiments, a TWT requesting STA or a TWT scheduled STA can request to become a member of an MU-RTS TXS Mode 2-enabled TWT schedule or agreement if, in the EHT Capabilities element most recently sent by the TWT requesting STA or TWT scheduled STA, the Triggered TXOP Sharing Mode 2 Support subfield is set to 1.

According to one embodiment, a TWT responding STA or a TWT scheduled STA that is a member of an MU-RTS TXS Mode 2-enabled TWT schedule or agreement can set up P2P sessions with its peer STA such that the start time, end time, and periodicity of the P2P sessions are synchronized with those of the TWT SP corresponding to the MU-RTS TXS Mode 2-enabled TWT schedule or agreement. Accordingly, upon receiving an MU-RTS TXS Trigger frame with the Triggered TXOP Sharing Mode subfield in the Common Info field set to 2 during the MU-RTS TXS Mode 2-enabled TWT SP, the member TWT responding STA or TWT scheduled STA can start sending frames to its peer STA.

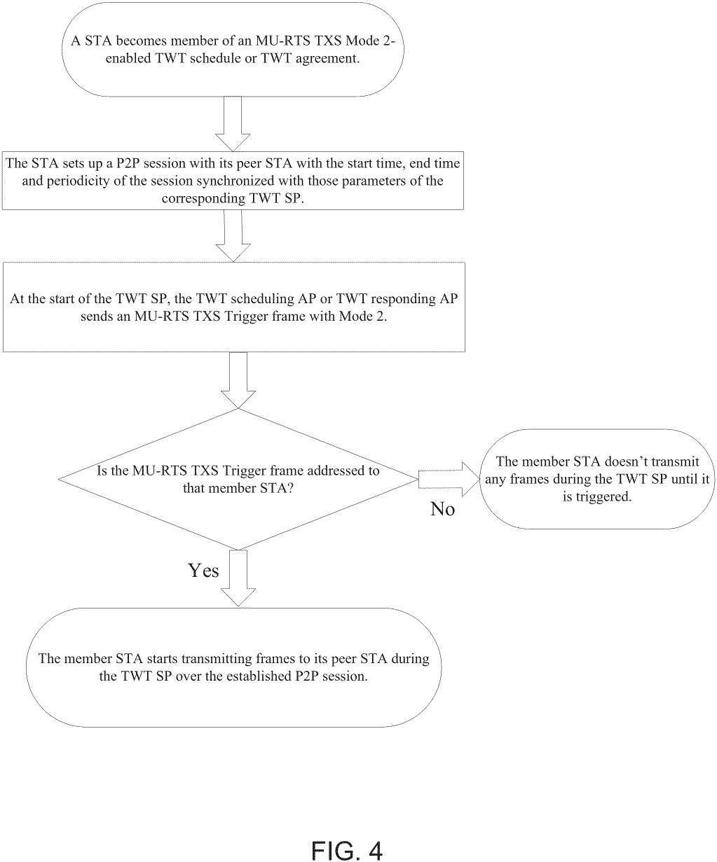

FIG. 4 illustrates an example process for triggered TXOP sharing for P2P communication during a TWT SP with a P2P session that is synchronized with parameters of the TWT SP according to various embodiments of the present disclosure. The example process of FIG. 4 may be used with the example scenario illustrated in FIG. 3.

According to another embodiment, the TWT scheduled STA or TWT requesting STA first sets up the P2P sessions with its peer STA and then negotiates for membership of the MU-RTS TXS Mode 2-enabled TWT schedule or agreement such that the TWT parameters of the MU-RTS TXS Mode 2-enabled TWT schedule are synchronized with those of the already established P2P session (e.g., the start time, end time, and periodicity of the TWT SP are synchronized with those of the P2P sessions).

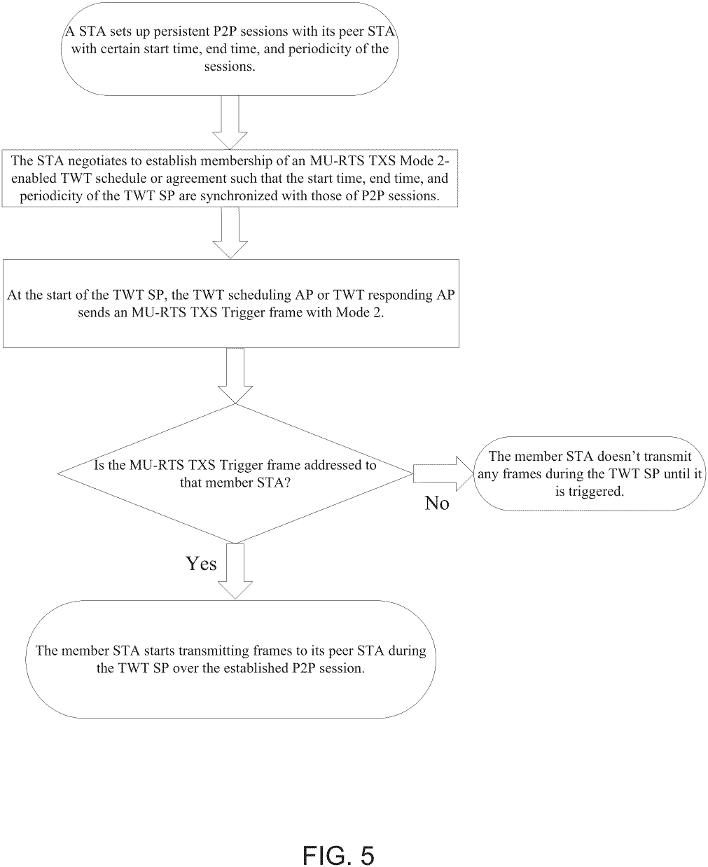

FIG. 5 illustrates an example process for triggered TXOP sharing for P2P communication during a TWT SP that is synchronized with parameters of the P2P session according to various embodiments of the present disclosure. The example process of FIG. 5 may be used with the example scenario illustrated in FIG. 3.

According to one embodiment, during a TWT SP corresponding to an MU-RTS TXS Mode 2-enabled TWT schedule or agreement, the STA that is a member of that schedule or agreement can only send non-trigger based (non-TB) physical layer protocol data units (PPDUs) during the TWT SP corresponding to the MU-RTS TXS Mode 2-enabled TWT schedule or agreement.

According to another embodiment, if an MU-RTS TXS Mode 2-enabled TWT schedule is also a restricted TWT schedule, then a restricted TWT scheduled STA that is a member of that schedule can only transmit latency sensitive traffic identified by the traffic identifiers (TIDs) negotiated through the restricted TWT setup procedure during the TWT SP corresponding to the MU-RTS TXS Mode 2-enabled TWT schedule.

According to another embodiment, multiple non-AP STAs can obtain membership of an MU-RTS TXS Mode 2-enabled TWT schedule, and during the TWT SP corresponding to the MU-RTS TXS Mode 2-enabled TWT schedule the TWT scheduling AP can send the MU-RTS TXS Trigger frame addressed to more than one of the multiple TWT scheduled STAs that are members of that TWT schedule by including more than one User Info field in the MU-RTS TXS Trigger frame, with AID12 subfields of the User Info fields that correspond to 12 LSBs of the AIDs of the corresponding scheduled STAs that are members of the MU-RTS TXS Mode 2-enabled TWT schedule.

According to one embodiment, an AP can send an MU-RTS TXS (Mode 2) Trigger frame to multiple non-AP STAs to allocate different portions of one TXOP to each of the non-AP STAs. The trigger frame can contain information on which portion of the TXOP is assigned to each one of the multiple non-AP STAs.

According to some embodiments, when an AP indicates TXOP allocation for P2P communications to more than one non-AP STA by sending an MU-RTS TXS (Mode 2) Trigger frame to each of the non-AP STAs, where the MU-RTS TXS (Mode 2) Trigger frame contains TXOP allocation information for those non-AP STAs, if the STAs had indicated that the STAs would need the TXOP for P2P communication using some TWT SPs, then the AP can assign the TXOP allocation in the MU-RTS TXS (Mode 2) Trigger frame to those STAs such that the TXOP allocation for each STA is aligned with the respective TWT SP for that STA for P2P communications.

According to one embodiment, the time interval indicated in the Duration field of the MU-RTS TXS Trigger frame sent during the MU-RTS TXS Mode 2-enabled TWT SP should not exceed the duration of the corresponding TWT SP.

According to one embodiment, the TWT responding AP or TWT scheduling AP can send an MU-RTS TXS Trigger frame with the Triggered TXOP Sharing Mode subfield of the Common Info field of the EHT variant MU-RTS TXS Trigger frame set to 2 at any point of time during the corresponding TWT SP. That is, the AP need not only send an MU-RTS TXS Trigger frame at the beginning of the TWT SP. Instead, the AP may, for example, allocate a beginning portion of the TXOP at the beginning of the TWT SP for a different purpose and send one or more different trigger frames earlier in the TWT SP for that purpose, and the AP may allocate a portion of the TXOP later in the TWT SP for triggered TXOP sharing for P2P communication.

In such an embodiment, upon receiving the MU-RTS TXS Trigger frame with the Triggered TXOP Sharing Mode subfield of the Common Info field of the EHT variant MU-RTS TXS Trigger frame set to 2 at any point during a Trigger enabled TWT SP, the STA that is a member of the corresponding TWT schedule or agreement can invoke a P2P session with its peer STA with the start time of the P2P session synchronized with the MU-RTS TXS Trigger frame reception time, and the end time of the P2P session synchronized with the end time of the corresponding TWT SP.

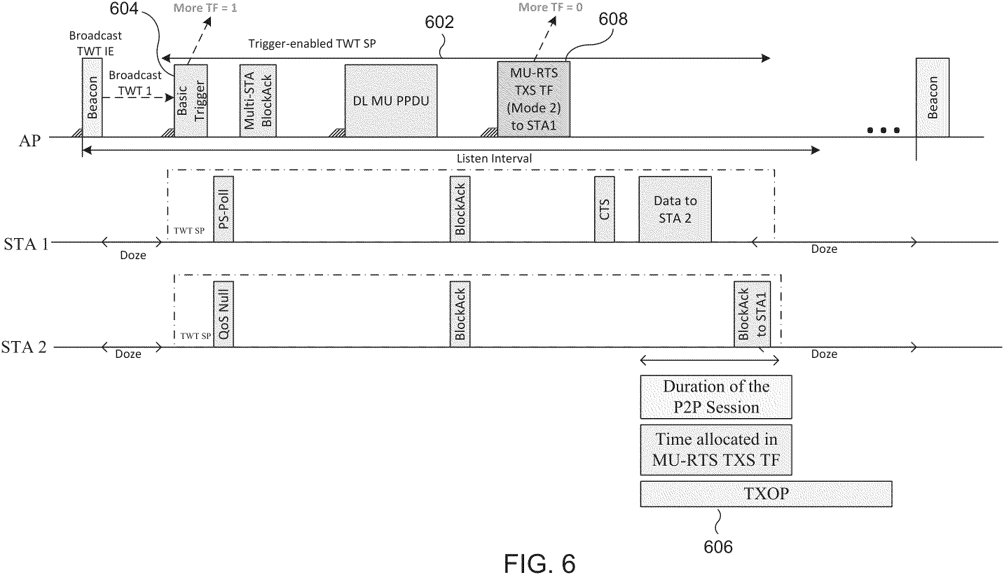

FIG. 6 illustrates an example of Triggered TXOP sharing for P2P communication during a TWT SP wherein an MU-RTS TXS Trigger frame is sent after a Basic Trigger frame according to various embodiments of the present disclosure. In the example of FIG. 6, the AP may be AP 101 and is a TWT scheduling AP or TWT responding AP, the STA 1 may be STA 111 and is a TWT scheduled STA or TWT requesting STA, and the STA 2 may be STA 112 and is a peer STA to STA 1. STA 1 is a member STA of an MU-RTS TXS Mode 2-enabled TWT schedule established by the AP.

In the example of FIG. 6, the AP has secured a TXOP that overlaps with an MU-RTS TXS Mode 2-enabled TWT SP 602 associated with the MU-RTS TXS Mode 2-enabled TWT schedule. The AP first initiates a non-TXOP sharing triggered operation by sending a Basic Trigger frame 604 during the TWT SP 602. In some embodiments, the AP may indicate in the Basic Trigger frame 604 that another trigger frame will be sent during the TWT SP 602.

The AP then allocates a remaining portion of the TXOP 606 for triggered TXOP sharing for P2P communications, which the AP initiates by sending MU-RTS TXS Trigger frame 608 with the Triggered TXOP Sharing Mode subfield in the Common Info field set to 2. Upon receiving the MU-RTS TXS Trigger frame 608 with the Triggered TXOP Sharing Mode subfield in the Common Info field set to 2 at any point in time during the MU-RTS TXS Mode 2-enabled TWT SP 602, STA 1 can invoke a P2P session with its peer STA 2 for the remaining duration of the TWT SP 602 and start sending frames to STA 2.

According to one embodiment, with respect to restricted TWT operation, an MU-RTS TXS Trigger frame with Mode 2 can be sent only during a restricted TWT SP corresponding to a restricted TWT schedule that has been identified as for P2P communication (either only for P2P or for both P2P and UL/DL).

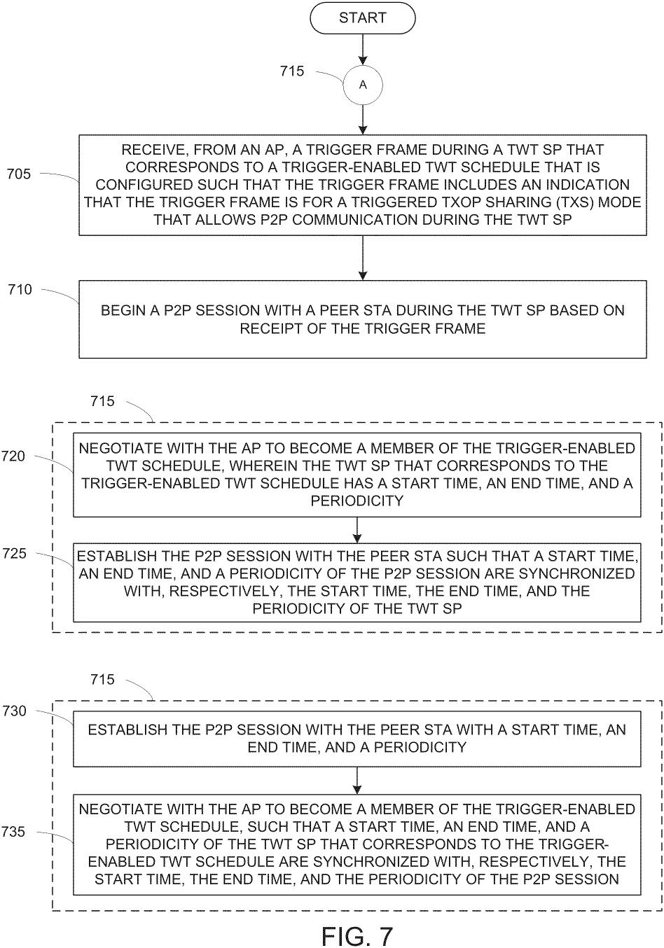

FIG. 7 illustrates an example process for using an MU-RTS TXS Mode 2-enabled TWT schedule to perform triggered TXOP sharing for P2P communication during the corresponding TWT SP according to various embodiments of the present disclosure. The process of FIG. 7 is discussed as being performed by a STA, but it is understood that an AP associated with the STA could perform a corresponding process. Additionally, for convenience, the process of FIG. 7 is discussed as being performed by a WI-FI STA such as STA 111, but it is understood that any suitable wireless communication device could perform the process.

Referring now to FIG. 7, beginning at step 705 the STA receives, from the AP, a trigger frame during a TWT SP that corresponds to a trigger-enabled TWT schedule that is configured such that the trigger frame includes an indication that the trigger frame is for a triggered TXOP sharing (TXS) mode that allows P2P communication during the TWT SP. The trigger-enabled TWT schedule may be configured such that all trigger frames sent during any TWT SP corresponding to the trigger-enabled TWT schedule include the indication that the trigger frame is for the triggered TXS mode that allows P2P communication during that TWT SP.

The trigger frame may be an MU-RTS trigger frame, the triggered TXS mode that allows P2P communication is MU-RTS TXS Mode 2, and a Triggered TXOP Sharing Mode subfield in a Common Info field of the MU-RTS trigger frame is set to a value of 2 to indicate that the MU-RTS trigger frame is for MU-RTS TXS Mode 2. In some embodiments, the STA receives the trigger frame only at the beginning of the TWT SP. In other embodiments the STA can receive the trigger frame at any point in time during the TWT SP.

Next, based on receipt of the trigger frame, the STA begins a P2P session with a peer STA during the TWT SP (step 710). In embodiments in which the STA can receive the trigger frame at any point in time during the TWT SP, at step 710 the STA begins the P2P session with the peer STA during the TWT SP such that an end time of the P2P session is synchronized with an end time of the TWT SP.

In some embodiments, before step 710 the STA determines whether the trigger frame is addressed to the STA, and proceeds to begin the P2P session at step 710 after determining that the trigger frame is addressed to the STA. If the trigger frame is not addressed to the STA, the STA may ignore the trigger frame instead of performing step 710.

The STA may become a member of the trigger-enabled TWT schedule and establish the P2P session in various ways before receiving the trigger frame at step 705, as illustrated by sub-process 715.

In one embodiment of sub-process 715, the STA first negotiates with the AP to become a member of the trigger-enabled TWT schedule, wherein the TWT SP that corresponds to the trigger-enabled TWT schedule has a start time, an end time, and a periodicity (step 720). After becoming a member of the trigger-enabled TWT schedule, the STA establishes the P2P session with the peer STA such that a start time, an end time, and a periodicity of the P2P session are synchronized with, respectively, the start time, the end time, and the periodicity of the TWT SP (step 725).

In an alternative embodiment of sub-process 715, the STA first establishes the P2P session with the peer STA with a start time, an end time, and a periodicity (step 730). After establishing the P2P session, the STA negotiates with the AP to become a member of the trigger-enabled TWT schedule, such that a start time, an end time, and a periodicity of the TWT SP that corresponds to the trigger-enabled TWT schedule are synchronized with, respectively, the start time, the end time, and the periodicity of the P2P session (step 735).

The above flowchart illustrates an example method that can be implemented in accordance with the principles of the present disclosure and various changes could be made to the methods illustrated in the flowchart. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A wireless station (STA) device comprising:
a transceiver configured to receive, from an access point (AP), a trigger frame during a target wake time (TWT) service period (SP) that corresponds to a trigger-enabled TWT schedule that is configured such that the trigger frame includes an indication that the trigger frame is for a triggered transmission opportunity sharing (TXS) mode that allows peer-to-peer (P2P) communication during the TWT SP; and
a processor operably coupled to the transceiver, the processor configured to, based on receipt of the trigger frame, begin a P2P session with a peer STA during the TWT SP.

2. The STA of claim 1, wherein:
the trigger frame is a multi-user request to send (MU-RTS) trigger frame,
the triggered TXS mode that allows P2P communication is MU-RTS TXS Mode 2, and
a Triggered TXOP Sharing Mode subfield in a Common Info field of the MU-RTS trigger frame is set to a value of 2 to indicate that the MU-RTS trigger frame is for MU-RTS TXS Mode 2.

3. The STA of claim 1, wherein the processor is further configured to:
negotiate with the AP to become a member of the trigger-enabled TWT schedule, wherein the TWT SP that corresponds to the trigger-enabled TWT schedule has a start time, an end time, and a periodicity; and
after becoming a member of the trigger-enabled TWT schedule, establish the P2P session with the peer STA such that a start time, an end time, and a periodicity of the P2P session are synchronized with, respectively, the start time, the end time, and the periodicity of the TWT SP.

4. The STA of claim 1, wherein the processor is further configured to:
establish the P2P session with the peer STA with a start time, an end time, and a periodicity; and
after establishing the P2P session, negotiate with the AP to become a member of the trigger-enabled TWT schedule, such that a start time, an end time, and a periodicity of the TWT SP that corresponds to the trigger-enabled TWT schedule are synchronized with, respectively, the start time, the end time, and the periodicity of the P2P session.

5. The STA of claim 1, wherein the trigger-enabled TWT schedule is configured such that all trigger frames sent during any TWT SP corresponding to the trigger-enabled TWT schedule include the indication that the trigger frame is for the triggered TXS mode that allows P2P communication during that TWT SP.

6. The STA of claim 1, wherein:
the transceiver is further configured to receive the trigger frame at any point in time during the TWT SP, and
the processor is further configured to, based on receipt of the trigger frame, begin the P2P session with the peer STA during the TWT SP such that an end time of the P2P session is synchronized with an end time of the TWT SP.

7. The STA of claim 1, wherein the processor is further configured to:
determine whether the trigger frame is addressed to the STA; and
begin the P2P session with the peer STA after a determination that the trigger frame is addressed to the STA.

8. An access point (AP) device comprising:
a transceiver; and
a processor operably coupled to the transceiver, the processor configured to:
determine to allow a wireless station (STA) to perform peer-to-peer (P2P) communication during a target wake time (TWT) service period (SP) that corresponds to a trigger-enabled TWT schedule, and
generate a trigger frame that includes an indication that the trigger frame is for a triggered transmission opportunity sharing (TXS) mode that allows the P2P communication during the TWT SP that corresponds to the trigger-enabled TWT schedule,
wherein the transceiver is configured to transmit, to the STA, the trigger frame to trigger the STA to begin a P2P session with a peer STA during the TWT SP.

9. The AP of claim 8, wherein:
the processor is further configured to generate the trigger frame as a multi-user request to send (MU-RTS) trigger frame,
the triggered TXS mode that allows P2P communication is MU-RTS TXS Mode 2, and
the processor is further configured to set a Triggered TXOP Sharing Mode subfield in a Common Info field of the MU-RTS trigger frame to a value of 2 to indicate that the MU-RTS trigger frame is for MU-RTS TXS Mode 2.

10. The AP of claim 8, wherein the processor is further configured to negotiate with the STA to make the STA a member of the trigger-enabled TWT schedule, wherein the TWT SP that corresponds to the trigger-enabled TWT schedule has a start time, an end time, and a periodicity, such that after becoming a member of the trigger-enabled TWT schedule, the STA is able to establish the P2P session with the peer STA such that a start time, an end time, and a periodicity of the P2P session are synchronized with, respectively, the start time, the end time, and the periodicity of the TWT SP.

11. The AP of claim 8, wherein the processor is further configured to, after the P2P session has been established between the STA and the peer STA, negotiate with the STA to make the STA a member of the trigger-enabled TWT schedule, such that a start time, an end time, and a periodicity of the TWT SP that corresponds to the trigger-enabled TWT schedule are synchronized with, respectively, a start time, an end time, and a periodicity of the P2P session.

12. The AP of claim 8, wherein the trigger-enabled TWT schedule is configured such that all trigger frames sent during any TWT SP corresponding to the trigger-enabled TWT schedule include the indication that the trigger frame is for the triggered TXS mode that allows P2P communication during that TWT SP.

13. The AP of claim 8, wherein the transceiver is further configured to transmit the trigger frame at any point in time during the TWT SP to trigger the STA to begin the P2P session with the peer STA during the TWT SP such that an end time of the P2P session is synchronized with an end time of the TWT SP.

14. The AP of claim 8, wherein the processor is further configured to address the trigger frame to the STA, such that the STA is triggered to begin the P2P session with the peer STA after a determination that the trigger frame is addressed to the STA.

15. A method for wireless communication performed by a wireless station (STA) device, the method comprising:
receiving, from an access point (AP), a trigger frame during a target wake time (TWT) service period (SP) that corresponds to a trigger-enabled TWT schedule that is configured such that the trigger frame includes an indication that the trigger frame is for a triggered transmission opportunity sharing (TXS) mode that allows peer-to-peer (P2P) communication during the TWT SP; and
beginning a P2P session with a peer STA during the TWT SP based on receipt of the trigger frame.

16. The method of claim 15, wherein:
the trigger frame is a multi-user request to send (MU-RTS) trigger frame,
the triggered TXS mode that allows P2P communication is MU-RTS TXS Mode 2, and
a Triggered TXOP Sharing Mode subfield in a Common Info field of the MU-RTS trigger frame is set to a value of 2 to indicate that the MU-RTS trigger frame is for MU-RTS TXS Mode 2.

17. The method of claim 15, further comprising:
negotiating with the AP to become a member of the trigger-enabled TWT schedule, wherein the TWT SP that corresponds to the trigger-enabled TWT schedule has a start time, an end time, and a periodicity; and
after becoming a member of the trigger-enabled TWT schedule, establishing the P2P session with the peer STA such that a start time, an end time, and a periodicity of the P2P session are synchronized with, respectively, the start time, the end time, and the periodicity of the TWT SP.

18. The method of claim 15, further comprising:
establishing the P2P session with the peer STA with a start time, an end time, and a periodicity; and
after establishing the P2P session, negotiating with the AP to become a member of the trigger-enabled TWT schedule, such that a start time, an end time, and a periodicity of the TWT SP that corresponds to the trigger-enabled TWT schedule are synchronized with, respectively, the start time, the end time, and the periodicity of the P2P session.

19. The method of claim 15, wherein the trigger-enabled TWT schedule is configured such that all trigger frames sent during any TWT SP corresponding to the trigger-enabled TWT schedule include the indication that the trigger frame is for the triggered TXS mode that allows P2P communication during that TWT SP.

20. The method of claim 15, further comprising:
receiving the trigger frame at any point in time during the TWT SP, and
based on receipt of the trigger frame, beginning the P2P session with the peer STA during the TWT SP such that an end time of the P2P session is synchronized with an end time of the TWT SP.
